(19) United States
(12) Patent Application Publication
(10) Pub. No.: US 2007/0292338 A1
(43) Pub. Date: Dec. 20, 2007

(54) Transition Metal Oxide Nano-Tube

(76) Inventors: Masaki Kogiso, Ibaraki (JP); Toshimi Shimizu, Ibaraki (JP)

Correspondence Address: GARY C. COHN, PLLC, 1147 NORTH FOURTH STREET, UNIT 6E, PHILADELPHIA, PA, 19123, US

(21) Appl. No.: 11/667,880

(22) PCT Filed: Sep. 12, 2005
(86) PCT No.: PCT/JP05/16732

§ 371 Date: May 15, 2007

(30) Foreign Application Priority Data
Feb. 24, 2005 (JP) 2005-048975

(51) Int. Cl. C01G 3/02; B82B 1/00; C01B 13/32; C01G 45/02; C01G 1/02

(52) U.S. Cl. 423/604; 423/605

(57) ABSTRACT

To provide nano-tubes consisting of transition metal oxide and a production method thereof. The nano-tubes consisting of a transition metal oxide with an average diameter of about 10 to 1,000 nm and an average length of about 1 to 100 μm can be obtained by coexisting a peptide lipid represented by the general formula RCO(NHCH₂CO)ₘOH, wherein R represents a hydrocarbon group with six to eighteen carbon atoms and m represents an integer one to three, and a transition metal ion in water and sintering at 300 to 600° C. the fibrous substance formed.

### TECHNICAL FIELD

The present invention relates to nano-tubes consisting of a transition metal oxide.

### BACKGROUND OF THE INVENTION

In a conventional method to prepare metal oxide nano-tubes, a two step production process has been used, which comprises (1) forming oxides of metals, such as silicon, titanium, zirconium and the like, on surfaces of rod shaped and hollow fibers formed from lipids and the like as a casting form by using a sol-gel method and (2) sintering the fibers at high temperatures to eliminated the fibers to yield metal oxide nano-tubes (Non-patent Reference 1 and Patent Reference 1).

In addition, some examples in which metal oxide nano-tubes were prepared using a solution method are also known(Non-patent Reference 2). However, metal oxide nano-tubes were formed only from limited transition metals such as zinc and the like.

Simultaneously, the present inventors have been pursuing research and development of nanofibers and hollow nanofibers comprising peptide lipids and transition metals by coordinating the peptide lipids formed by bonding valine, glycine and the like to long chain hydrocarbon groups and a transition metal in water (Patent References 2 and 3 and Non-patent Reference 3).

Patent Reference 1: Japanese Patent Application Public Disclosure No. 2004-026509

Patent Reference 2: Japanese Patent Application Public Disclosure No. 2004-250797

Patent Reference 3: Japanese Patent No. 3560333

Non-patent Reference 1: Nano Letters, 2(1), 17-20, 2002

Non-patent Reference 2: Chem. Commun., 262-263, 2002

Non-patent Reference 3: J. Colloid Interface Sci., 273, 394-399, 2004

### PROBLEMS TO BE SOLVED BY THE INVENTION

Nano-tubes consisting of transition metal oxides have useful properties, and preparations thereof have been investigated by many researchers.

The previous metal oxide nano-tube synthesis methods based on a sol-gel process have not been popular since they were restricted to (Non-patent Reference 1) specific metals such as silicon, titanium, zirconium and the like, and a complicated two step reaction was required. Due to these reasons, transition metal oxide nano-tubes have not be manufactured.

In addition, metal oxide nano-tube synthesis methods based on a solution process were not applicable to versatile transition metals other than limited metals such as zinc and the like (Non-patent Reference 2).

That is, the objective of the present invention is to present nano-tubes consisting of transition metal oxides and a simple method to manufacture them.

### MEANS TO SOLVE THE PROBLEMS

The present inventors had already developed a technology to synthesize peptide lipid nanofibers on which a variety of transition metal ions are coordinated (Non-patent Reference 3 and Patent Reference 3), but hollow nanofibers consisting of these transition metal ions are not yet available in the world.

The present inventors conducted intensive studies to solve the problem described above. As a result, the present inventors discovered that transition metal oxide tubes could be formed using a one step reaction when hollow nanofibers comprising a peptide lipid and a transition metal are used as self casting forms, the peptide lipid in the hollow nanofibers is decomposed and removed and the transition metal ions are oxidized by sintering at high temperatures. The present invention was completed based on the discovery.

The present invention is a revolutionary invention of discovering a very simple previously desired but not obtainable production method for nano-tubes comprising a transition metal oxide.

### ADVANTAGE OF THE INVENTION

The transition metal oxide nano-tubes of the present invention can be utilized as nano electronic parts and nano magnetic materials in industrial fields such as the electronics, information and electronics fields.

### BRIEF DESCRIPTION OF THE DRAWINGS

FIG. 1 shows the infrared absorption spectrum of copper oxide nanotubes.

FIG. 2 shows the transmission type electron microscope photograph of copper oxide nanotubes.

FIG. 3 shows the infrared absorption spectrum of manganese oxide nanotubes.

FIG. 4 shows the transmission type electron microscope photograph of manganese oxide nanotubes.

### DETAILED DESCRIPTION OF THE INVENTION

First, a casting form of hollow nanofibers is formed by allowing a peptide lipid and transition metal ions to coexist in water.

The peptide lipid can be represented by the general formula RCO(NHCH₂CO)ₘOH.

In this formula, R is a hydrocarbon group with 6-18 carbon atoms and is preferably a linear hydrocarbon containing side chains with two or fewer carbon atoms. This hydrocarbon group may be saturated or unsaturated. The presence of three or fewer double bonds is preferred when the hydrocarbon group is unsaturated.

The glycine radical bonded to the hydrocarbon group by a peptide bond plays a unique role in the present invention. The thinking is that the glycine forms a hydrogen bond referred to as a polyglycine (II) type structure (Crick, F. H. C., Rich, A., Nature 1955, 176, 780-781) that assumes a hollow fiber type structure. When the glycine radical is replaced with other amino acids, only fibrous construction materials are formed under ordinary conditions and no hollow fiber type construction material is formed as is formed in the present invention using a glycine radical.

Transition elements are metals from ²¹Sc to ³⁰Zn, from ³⁹Y to ⁴⁸Cd and from ⁵⁷La to ⁸⁰Hg, and manganese, iron, cobalt, nickel, copper, zinc, silver, palladium, gold and platinum are preferred. These elements may be used individually or as a mixture of multiple types, but the use of an individual element is preferred.

Casting forms for hollow nanofibers are instantly formed when the peptide lipid and the transition metal ions described above are allowed to coexist in water. More specifically, the peptide lipid described above is first dissolved in water. A carboxylate anion is formed on the lipid terminals by adding a base to the peptide lipid. As the base, relatively strong bases such as alkali metal hydroxides (sodium hydroxide, lithium hydroxide, potassium hydroxide and the like) and tetra-alkyl ammonium hydroxides (tetra-methyl ammonium hydroxide, tetra-ethyl ammonium hydroxide and the like) and the like are suitable. A peptide lipid concentration at this point of 1-50 millimoles/liter is preferred. Now solvents other than water may also be acceptable, but water is most preferred based on the test results available at this time. Next, a transition metal ion is added, and a precursor of any construction that forms a transition metal in water may be used. A transition metal salt is most convenient, and transition metal salts such as hydrochlorides, sulfates, nitrates, acetates and the like may be used.

Carboxylate anions and transition metal ions react immediately in water in the manner described above to form materials in which a peptide lipid and a transition metal are bonded, and the bonded materials are self aggregating. Hollow nanofibers are instantly formed when transition metal ions are added, and the rate at which a transition metal is supplied may be decided appropriately upon observing the formation status of the hollow nanofibers. The temperature at this point may be any temperature, and the reaction proceeds adequately at room temperature.

A stable hollow nanofiber is obtained in air by capturing the fibrous substance and air drying or vacuum drying the fiber.

The hollow nanofiber casting forms are thought to comprise compounds represented by the following formula
RCO(NHCH₂CO)ₘOX
(in the formula, R and m are as described above and X represents a transition metal ion) in which a carboxylate anion of a peptide lipid and a transition metal ion are bonded.

The hollow nanofiber casting forms form a layer about 4.4 nm thick wherein the transition metal is coordinated on the outside and the peptide lipid is coordinated on the inside. Hollow nanofibers are constructed by having multiple numbers of layers (about five to ten layers) surround the hollow section. As a result, the film thickness of the tubes is about 20 to 50 nm. The average diameter of the hollow nanofibers is about 10 to 1,000 nm, and the average length is about 1 to 100 μm.

Next, the hollow nanofiber casting form obtained is sintered for about five hours at 300 to 600° C. in a trace air flow, for example, a flow of about 100 ml/minute.

Nano-tubes consisting of transition metal oxide are obtained as a result, and the sizes of the nano-tubes are the same as those of the casting forms with an average diameter of about 10 to 1,000 nm and an average length of about 1 to 100 μm.

The nano-tubes can be easily observed using an ordinary optical microscope. The structures can be confirmed in further detail by using a laser microscope, an interatomic force microscope and an electron microscope.

The present invention is illustrated in the following Examples, but these Examples are not intended to limit the scope of the present invention

### PRODUCTION EXAMPLE 1

Triethylamine [0.31 ml (2.2 millimoles)] was added to 0.57 g (2.2 millimoles) of glycylglycine benzyl ester hydrochloride, and the mixture was dissolved in 10 ml of ethanol. Fifty milliliters of a chloroform solution containing 0.40 g (2 millimoles) of undecane carboxylic acid was added. The mixed solution was cooled to −10° C., and 20 ml of a chloroform solution containing 0.42 g (2.2 millimoles) of 1-ethyl-3-(3-dimethylaminopropyl) carbodiimide hydrochloride was added with cooling. The mixture obtained was agitated a day and a night while allowing the temperature to gradually rise to room temperature. The reaction solution was washed using 50 ml of 10% by weight of an aqueous citric acid solution, 50 ml of 4% by weight of an aqueous sodium bicarbonate solution and 50 ml of water in that order. The solution was subsequently concentrated under reduced pressure, and 0.50 g (60% yield) of N-(glycylglycine benzyl ester) undecane carboxamide was obtained in the form of white solids. The compound [0.42 g (1 millimole)] was dissolved in 100 ml of dimethyl formamide, and catalytic hydrogen reduction was allowed to occur by adding 0.5 g of 10% by weight palladium on carbon as the catalyst. After six hours, the catalyst was separated by filtration using Celite and the solution was concentrated under reduced pressure to obtain 0.16 g (50% yield) of peptide lipid [N-(glycylglycine) undecane carboxamide] in the form of white solids. The physical properties and elemental analysis results for the product are shown below.

| Melting point: | 160° C. | | |
|---|---|---|---|
| Elemental analysis: | (C₁₆H₃₀N₂O₄•0.5H₂O): | | |
| | C | H | N |
| Calculated value (%): | 59.41 | 9.662 | 8.663 |
| Actual value (%): | 60.09 | 9.341 | 8.583 |

### PRODUCTION EXAMPLE 2

One millimole of the peptide lipid obtained in Production Example 1 was placed in a jar, and 50 ml of distilled water containing a one fold equivalent of sodium hydroxide [40 mg (1 millimole)] was added. The container was subjected to an ultrasound sonication (a bath type) to dissolve the peptide lipid. The solution became turbid instantly when 50 ml (0.5 millimole) of a 20 millimole/liter solution of copper (II) acetate was added to the aqueous solution at ambient temperature and pressure, and a blue precipitate formed.

The precipitate was examined using infrared absorption spectroscopy. The unique absorption band associated with a carboxylate anion of a peptide lipid sodium salt at 1604 cm⁻¹ disappeared, and the absorption band at 1408 cm⁻¹ made a large shift to around 1419 cm⁻¹. A unique phenomenon observed when a metal ion is coordinated to a carboxylate anion was reflected in the results, and the results proved that the precipitate comprised a peptide lipid and a metal ion. The precipitate was examined using a transmission type electron microscope, and the formation of hollow nanofibers with an average diameter of 10 to 1,000 nm and an average length of 1 to 100 μm comprising a peptide lipid and copper (II) ion was confirmed.

### PRODUCTION EXAMPLE 3

One millimole of the peptide lipid obtained in Production Example 1 was placed in a jar, and 50 ml of distilled water containing a one fold equivalent of sodium hydroxide [40 mg (1 millimole)] was added. The container was subjected to an ultrasound sonication (a bath type) to dissolve the peptide lipid. The solution became turbid instantly when 50 ml (0.5 millimole) of 20 millimole/liter of manganese (II) acetate was added to the aqueous solution at ambient temperature and pressure, and a blue precipitate formed.

The precipitate was examined using infrared absorption spectroscopy. The unique absorption band associated with a carboxylate anion of a peptide lipid sodium salt at 1604 cm⁻¹ disappeared, and the absorption band at 1408 cm⁻¹ made a large shift to around 1419 cm⁻¹. A unique phenomenon observed when a metal ion is coordinated to a carboxylate anion was reflected in the results, and the results proved that the precipitate comprised a peptide lipid and a metal ion. The precipitate was examined using a transmission type electron microscope, and the formation of hollow nanofibers with an average diameter of 10 to 1,000 nm and an average length of 1 to 100 μm comprising a peptide lipid and manganese (II) ion was confirmed.

### EXAMPLE 1

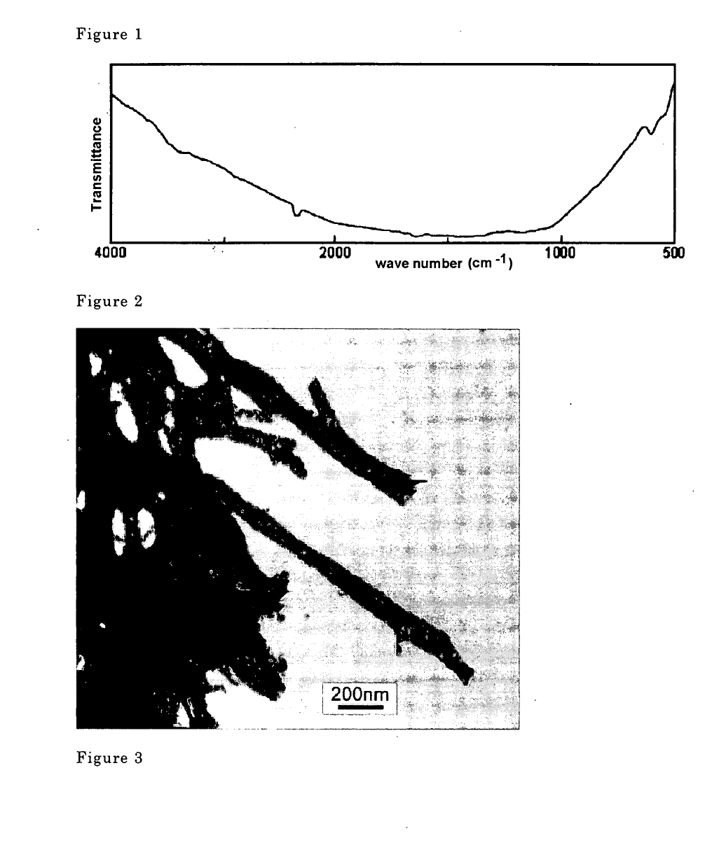

The hollow nanofiber powder comprising peptide lipid and copper obtained in Production Example 2 was heated for four hours at 400° C. in a trace flow of air. The gray black powder obtained was examined using infrared absorption spectroscopy, and the results indicated that the peptide lipid was completely decomposed by the heating and had disappeared. The results also indicated that the copper ion was oxidized and copper oxide was formed (FIG. 1). Upon examining the product using an electron microscope, the formation of copper oxide tubes with an average diameter of 60 to 100 nm and length of 1 to 10 μm was clearly indicted (FIG. 2). The thinking is that hollow nanofibers comprising peptide lipid and copper used themselves as casting forms and formed copper oxide nano-tubes of the same shape.

### EXAMPLE 2

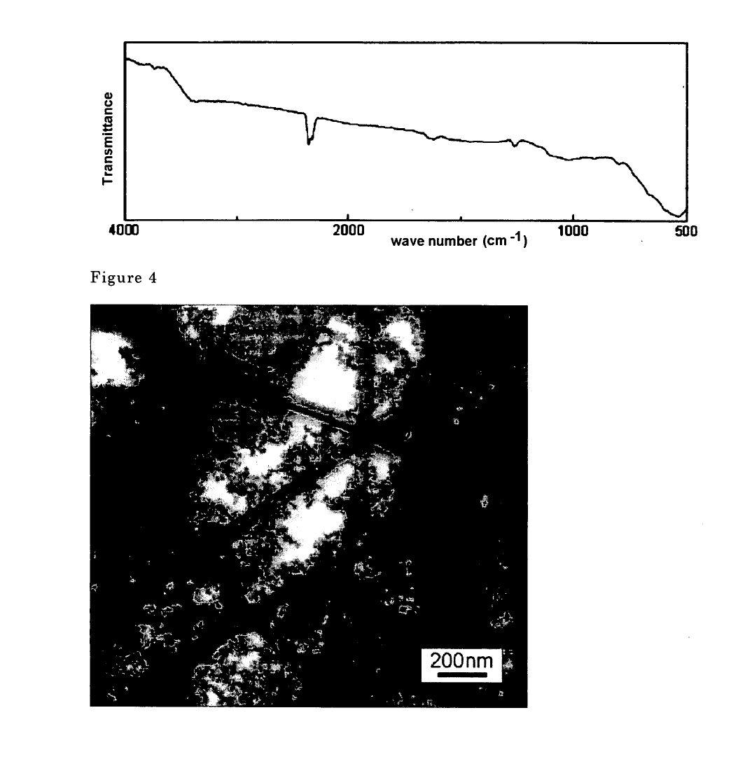

The hollow nanofiber powder comprising peptide lipid and manganese obtained in Production Example 3 was heated for four hours at 400° C. in a trace flow of air. The gray black powder obtained was examined using infrared absorption spectroscopy, and the results indicated that the peptide lipid was completely decomposed by the heating and had disappeared. The results also indicated that the manganese ion was oxidized and manganese oxide was formed (FIG. 3). Upon examining the product using an electron microscope, the formation of manganese oxide tubes with an average diameter of 50 to 200 nm and length of 1 to 10 μm was clearly indicted (FIG. 4). The thinking is that hollow nanofibers comprising peptide lipid and manganese used themselves as casting forms and formed manganese oxide nano-tubes of the same shape.

1. A nano-tube consisting of transition metal oxide, which has an average diameter of about 10 to 1,000 nm and an average length of about 1 to 100 μm.

2. The nano-tube of claim 1, wherein the transition metal is any one of the metals from ²¹Sc to ³⁰Zn, from ³⁹Y to ⁴⁸Cd and from ⁵⁷La to ⁸⁰Hg or a mixture thereof.

3. A method to produce a transition metal oxide nano-tube comprising allowing to coexist a peptide lipid represented by the general formula
RCO(NHCH₂CO)ₘOH
wherein R represents a hydrocarbon group with six to eighteen carbon atoms and m represents an integer one to three, and a transition metal ion in water to form a fibrous substance and sintering the fibrous substance at 300 to 600° C.

4. The method of claim 3, wherein R is a linear hydrocarbon.

5. The method of claim 3, wherein the transition metal is any one of the metals from ²¹Sc to ³⁰Zn, from ³⁹Y to ⁴⁸Cd and from ⁵⁷La to ⁸⁰Hg or a mixture thereof.

6. The method of claim 5, wherein the transition metal oxide nano-tube consists of transition metal oxide and has an average diameter of about 10 to 1,000 nm and an average length of about 1 to 100 μm.

7. The method of claim 4, wherein the transition metal is any one of the metals from ²¹Sc to ³⁰Zn, from ³⁹Y to ⁴⁸Cd and from ⁵⁷La to ⁸⁰Hg or a mixture thereof.

8. The method of claim 7, wherein the transition metal oxide nano-tube consists of transition metal oxide and has an average diameter of about 10 to 1,000 nm and an average length of about 1 to 100 μm.

9. The method of claim 3, wherein the transition metal oxide nano-tube consists of transition metal oxide and has an average diameter of about 10 to 1,000 nm and an average length of about 1 to 100 μm.

10. A transition metal oxide nano-tube, which is produced by the method of claim 3, wherein the transition metal oxide nano-tube consists of transition metal oxide and has an average diameter of about 10 to 1,000 nm and an average length of about 1 to 100 μm.

11. A transition metal oxide nano-tube, which is produced by the method of claim 4, wherein the transition metal oxide nano-tube consists of transition metal oxide and has an average diameter of about 10 to 1,000 nm and an average length of about 1 to 100 μm.

12. A transition metal oxide nano-tube, which is produced by the method of claim 5, wherein the transition metal oxide nano-tube consists of transition metal oxide and has an average diameter of about 10 to 1,000 nm and an average length of about 1 to 100 μm.

13. A transition metal oxide nano-tube, which is produced by the method of claim 6, wherein the transition metal oxide nano-tube consists of transition metal oxide and has an average diameter of about 10 to 1,000 nm and an average length of about 1 to 100 μm.

14. A transition metal oxide nano-tube, which is produced by the method of claim 7, wherein the transition metal oxide nano-tube consists of transition metal oxide and has an average diameter of about 10 to 1,000 nm and an average length of about 1 to 100 μm.

15. A transition metal oxide nano-tube, which is produced by the method of claim 8, wherein the transition metal oxide nano-tube consists of transition metal oxide and has an average diameter of about 10 to 1,000 nm and an average length of about 1 to 100 μm.

16. A transition metal oxide nano-tube, which is produced by the method of claim 9, wherein the transition metal oxide nano-tube consists of transition metal oxide and has an average diameter of about 10 to 1,000 nm and an average length of about 1 to 100 μm.
